(19) United States
(12) Patent Application Publication
(10) Pub. No.: US 2020/0307996 A1
(43) Pub. Date: Oct. 1, 2020

(54) COMPOSITION FOR GENERATING HYDROGEN

(71) Applicant: IHOD LIMITED, Berkshire (GB)

(72) Inventors: Mark Collins, Berkshire (GB); Chase Collins, Berkshire (GB); Ertan Siddiqui, Berkshire (GB)

(21) Appl. No.: 16/954,630

(22) PCT Filed: Dec. 17, 2018
(86) PCT No.: PCT/EP2018/085227

§ 371 Date: Jun. 17, 2020

(30) Foreign Application Priority Data
Dec. 18, 2017 (GB) 1721129.3

(51) Int. Cl. C01B 3/04; C01B 3/06; C01B 3/08

(52) U.S. Cl. CPC C01B 3/042; C01B 2203/0266; C01B 3/08; C01B 3/061

(57) ABSTRACT

The invention provides particulate compositions, which generate hydrogen when contacted with water, the compositions comprising particles of:
aluminium;
one or more metal oxides; and
one or more chloride salts of alkali metals or alkaline earth metals.

The invention also provides methods of preparing such compositions and methods of generating hydrogen by contacting the compositions with water.

### RELATED APPLICATIONS

This application is a US National stage entry of International Application No. PCT/EP2018/085227, which designated the United States and was filed on Dec. 17, 2018, published in English.

This application claims priority under 35 U.S.C. § 119 or 365 to GB, Application No. 1721129.3, filed Dec. 18, 2017. The entire teachings of the above applications are incorporated herein by reference.

This invention relates to compositions for use in generating hydrogen gas, methods of preparing such compositions and methods of generating hydrogen gas using the compositions.

### BACKGROUND OF THE INVENTION

Increasing awareness of climate change and growing energy demand has led to a significant amount of research and development activities into alternative energy sources, such as hydrogen.

Hydrogen can be used as a fuel for fuel cells to produce electric power and heat. Fuel cells convert the chemical energy from hydrogen into electricity through a chemical reaction with oxygen. The by-product of this reaction is water.

While hydrogen as a safe and clean fuel is gaining recognition, there is still cause for concern about the technologies currently used to generate H₂.

Steam can be reacted with methane at high temperatures (e.g. 700-1100° C.) in the presence of a metal-based catalyst (often nickel) to generate hydrogen gas. In this process, toxic carbon monoxide is produced as by-product and, in order to produce steam to react with the methane, large boilers or steam reformers are required.

Another hydrogen generation method involves the electrolysis of water, whereby an electric current is passed through water causing it to decompose into oxygen at the anode and hydrogen at the cathode.

Reactions between metals and water have also been extensively investigated. For example, aluminium metal reacts with water to generate hydrogen gas according to the following equation:

Al (s)+3H₂O (g)→Al(OH)₃ (s)+1.5H₂ (g)ΔHr=−280 kJ/mol.

However, a problem with the reaction between aluminium and water is that a protective coating of aluminium oxide is very rapidly formed on the surface of the metal thereby inhibiting further reaction. Therefore, after a short initial burst of hydrogen generation, further evolution of hydrogen ceases or proceeds only very slowly.

Various additives that can facilitate the reaction of aluminium with water have therefore been investigated.

Wang et. al. (“Preparation and Hydrolysis of Aluminium Based Composites for Hydrogen Production in Pure Water”, Materials Trans. (2014), 55, pp. 892-898) investigated the effect of additives including CaO, NaCl and low melting point metals (Ga, In and Sn) on the hydrolysis activity of aluminium in water. The total hydrogen yield (volume) per gram of aluminium for compositions containing a mixture of aluminium and CaO composites ranged from 10 to 110 mL. This is far below the maximum theoretical yield of (1358 mL) for 1 g Al reacting with water completely at 25° C. and 1 atmosphere of pressure. By adding NaCl to the Al—CaO compositions, the hydrogen yield increased, but only up to a maximum of 54% of the maximum theoretical yield. However, the authors of this paper found that by using aluminium alloys containing metals such as Ga, In and Sn in combination with CaO and NaCl, yields of greater than 80% could be obtained. However, even with the use of Ga, In and Sn alloys, yields of greater than 80% were only observed at high temperatures (60° C.). The use of such metals and the preparation of the aluminium alloys is expensive, and hence the commercial potential of such mixtures as fuel sources is limited.

Wang et. al. (“Generation of hydrogen from aluminium and water—Effect of metal oxide nanocrystals and water quality”, Int. J. Hydrog. Energy (2011), 36, pp. 15136-15144) also investigated the effect of the addition of various first-row transition metal oxide nanocrystals to the reaction between aluminium and water to generate hydrogen.

Dupiano et al. (“Hydrogen production by reacting water with mechanically milled composite aluminium-metal oxide powders”, Int. J. Hydrog. Energy (2011), 36, pp. 4781-4791) investigated the reaction of several mechanically milled aluminium-metal oxide powders with water. It was found that for the powder containing a mixture of aluminium and CuO, when conducted at room temperature, no reaction was observed for the first 3 days.

Chen et. al. (“Research of hydrogen generation by the reaction of Al-based materials with water”, J. Power Sources (2013), 222, pp. 188-195) investigated the reaction of various compositions containing Al, CaO and NaCl prepared by mechanical ball-milling for hydrogen production.

At the present time, there remains the need for hydrogen-generating compositions that can generate hydrogen gas in high yields at ambient temperatures. If they are to be used as fuels for generating hydrogen for consumption in fuel cells in a domestic setting, such compositions should also be relatively inexpensive to manufacture and safe to use in a domestic environment. In particular, the compositions should generate hydrogen in a controlled manner to avoid overheating and over-pressurisation of the hydrogen generating apparatuses in which the compositions may be used.

### The Invention

It is an object of the invention to provide a composition which generates hydrogen in high yields when contacted with water. Preferably, the release of hydrogen can be controlled so as to provide low pressures of hydrogen over a prolonged period.

It is a further object of the invention to provide compositions that are useful in generating hydrogen for conversion into electricity by hydrogen fuel cells in domestic environments.

Whilst the effects of the addition of single metal oxides and single metal chlorides to the reaction between aluminium and water have been investigated, the effects of using combinations of metal oxides or combinations of metal chlorides as additives has been unknown up until now.

It has now been found that by using a combination of an alkaline earth metal oxide and a transition metal oxide, the total volume of hydrogen produced is unexpectedly greater than when either one of the oxides is used alone (see Example 2 below).

Accordingly, in a first aspect of the invention there is provided a composition, which generates hydrogen when contacted with water, the composition comprising particles of:
aluminium;
an alkaline earth metal oxide;
a transition metal oxide; and
one or more chloride salts of alkali metals or alkaline earth metals.

The compositions typically comprise a plurality of chloride salts. The composition may comprise a salt comprising or consisting of sodium ions, potassium ions, calcium ions and chloride ions. In one embodiment, the composition comprises a mixture of NaCl, KCl and CaCl₂. In a further embodiment, the composition consists of or consists essentially of a mixture of NaCl, KCl and CaCl₂.

It has also been found that by using a combination of multiple metal chloride salts, the total volume of hydrogen generated is greater than when any one of the chloride salts is used alone (see Example 4 below).

Accordingly, in a second aspect of the invention, there is provided a particulate composition, which generates hydrogen when contacted with water, the composition comprising particles of:
aluminium;
one or more metal oxides; and
a mixture of NaCl, KCl and CaCl₂.

In this second aspect of the invention, the composition may advantageously comprise two or more metal oxides. In one embodiment, the composition comprises an alkaline earth metal oxide and a transition metal oxide.

In a third aspect of the invention, there is provided a particulate composition, which generates hydrogen when contacted with water, the composition comprising particles of:
aluminium;
an alkaline earth metal oxide;
a transition metal oxide; and
a mixture of NaCl, KCl and CaCl₂).

The compositions of the invention can be contacted with water to generate hydrogen gas in high yields at ambient temperatures. The hydrogen gas is released in a controlled manner over a period of up to 10,000 seconds (approx. 2.75 hours). The compositions of the invention also have the advantage that the they are relatively inexpensive to manufacture and safe to use in domestic settings.

The compositions are particulate in nature (i.e. they are formed from particles, for example particles having a diameter of less than 1 mm or less than 500 μm). The compositions are also anhydrous in that they do not contain water which could react with the aluminium before use in generating hydrogen.

The aluminium particles may have a diameter of less than 200 μm, typically less than 150 μm, for example less than 100 μm. The diameter of the aluminium particles is typically greater than 1 μm, for example greater than 10 μm or greater than 20 μm. In certain embodiments, the aluminium particles have a diameter of 1 μm to 200 μm, for example, 10 μm to 150 μm, e.g. 20 μm to 100 μm. The diameters stated above were measured using sieving methods. Therefore, the diameters refer to particles that are able or unable to pass through sieves with apertures of a certain size. For example, particles stated as having a diameter of less than 200 μm are able to pass through a circular aperture having a diameter of 200 μm, whereas particles stated as having a diameter of greater than 1 μm are unable to pass through a circular aperture having a diameter of 1 μm.

Compositions comprising particles of recycled aluminium have been found to be particularly advantageous (see Example 7 below). Accordingly, the compositions of the invention may comprise particles of recycled aluminium.

The aluminium particles may be present in an amount of 40% to 90% by weight of the total composition, typically in an amount of 50% to 80% by weight of the total composition, for example in an amount of 60% to 70% by weight of the total composition.

The metal oxide(s) is/are typically present in an amount of 20% to 30% by weight of the total composition. The amount of metal oxide(s) can be defined with respect to the amount of aluminium. Therefore, the metal oxide(s) composition may contain aluminium in an amount of 1 to 4, preferably 2 to 3, for example around 2.6 by weights times the amount of the metal oxide(s). Alternatively, the amount of metal oxide(s) can be defined by a weight ratio with respect to the amount of aluminium. Therefore, the aluminium and transition metal oxide may be present in a ratio of 1:1 to 4:1 by weight, typically 2:1 to 3:1 by weight, for example around 2.6:1 by weight.

The chloride salt(s) is/are typically present in an amount of 5% to 15% by weight of the total composition. The amount of chloride salt(s) can be defined with respect to the amount of aluminium. Therefore, the composition may contain aluminium in an amount of 5 to 8, preferably 6 to 7, for example around 6.5 by weights times the amount of the chloride salt(s). Alternatively, the amount of metal oxide(s) can be defined by a weight ratio with respect to the amount of aluminium. Therefore, the aluminium and salt(s) may be present in a ratio of 5:1 to 8:1 by weight, typically 7:1 to 6:1 by weight, for example around 6.5:1 by weight.

The alkaline earth metal oxide may be selected from calcium oxide, barium oxide, magnesium oxide or mixtures thereof. Typically, the alkaline earth metal oxide predominantly consists of calcium oxide. For example, the compositions may comprise calcium oxide in an amount of greater than 70% by weight, greater than 80% by weight, greater than 90% by weight or greater than 95% by weight of the total weight of alkaline earth metal oxides. In one embodiment, the alkaline earth metal is calcium oxide.

Certain compositions of the invention also comprise one or more transition metal oxides. The transition metal oxide may be a first-row transition metal oxide. The term “first-row transition metal oxide” includes oxides of scandium, titanium, vanadium, chromium, manganese, iron, cobalt, nickel, copper or zinc. Typically, the first-row transition metal oxides are oxides where the metal is in a +2 oxidation state (herein referred to as “first-row transition metal (II) oxides”). Examples of such first-row transition metal (II) oxides include copper (II) oxide, zinc oxide, iron (II) oxide, nickel (II) oxide and cobalt (II) oxide. Preferable, the first-row transition metal (II) oxide is selected from copper (II) oxide, iron (II) oxide, nickel (II) oxide or mixtures thereof. In certain embodiments, the compositions comprise one transition metal oxide. In one embodiment, the first-row transition metal oxide predominantly consists of copper (II) oxide (CuO). For example, the compositions may comprise copper (II) oxide in an amount of greater than 70% by weight, greater than 80% by weight, greater than 90% by weight or greater than 95% by weight of the total weight of transition metal oxides. In one embodiment, the transition metal oxide is CuO.

It has been found that the ratio of the alkaline earth metal oxide and the transition metal oxides can affect the hydrogen yield of the compositions (see Example 3 below).

Accordingly, the alkaline earth metal oxide and transition metal oxide may be present in a mutual ratio of 0.65:0.35 to 0.35:0.65 by weight, typically 0.6:0.4 to 0.4:0.6 by weight, for example 0.55:0.45 to 0.45:0.55 by weight. In one embodiment, the alkaline earth metal oxide and transition metal oxide are present in the composition of the invention in substantially equal amounts by weight (i.e. approximately 1:1 ratio).

The compositions of the invention comprise one or more chloride salts of alkali metals or alkaline earth metals. The salts may therefore be selected from potassium chloride (KCl), sodium chloride (NaCl), lithium chloride (LiCl), magnesium chloride (MgCl₂), calcium chloride (CaCl₂)), or mixtures thereof. Typically, the compositions comprise a plurality of chloride salts of alkali metals and/or alkaline earth metals. In one embodiment, the salts may be selected from KCl, NaCl, CaCl₂) or mixtures thereof.

Where multiple chloride salts are present in the composition, the ratio in which they are present may have an effect on the yield of hydrogen. Typically, the ratios of NaCl, KCl and CaCl₂) by weight may be 3.5-4.5:2.5-3.5:2.5-3.5, preferably, 3.75-4.25:2.75-3.25:2.75-3.25, for example approximately 4:3:3 respectively.

In one embodiment, there is provided a particulate composition, which generates hydrogen when contacted with water, the composition comprising:
60 to 70% by weight of aluminium;
10 to 15% by weight of a group II metal oxide;
10 to 15% by weight of a first-row transition metal oxide;
3.5 to 4.5% by weight of NaCl;
2.5 to 3.5% by weight of KCl; and
2.5 to 3.5% by weight of CaCl₂.

Whilst untreated mixtures of aluminium particles, metal oxides and/or chloride salts have been shown to generate hydrogen gas at good yields when contacted with water (see Example 5), the present inventors have also found that hydrogen yields for the compositions can be further improved by treating (for example, milling) the compositions before use in generating hydrogen.

Aluminium reacts rapidly with atmospheric oxygen to form a solid and dense coating of aluminium oxide on its surface. The presence of this oxide layer hinders the reaction between aluminium and water to generate hydrogen gas and consequently reduces the yield of hydrogen gas.

Accordingly, the aluminium particles present in the compositions of the inventions may be aluminium particles in which a proportion of the aluminium oxide layer has been removed, for example by mechanical means. The aluminium oxide layer may be removed or partially removed using a number of techniques including reactive ball milling or grinding. Alternatively, the aluminium may be treated with chemicals (such as alkaline solutions) to remove some of the aluminium oxide layer. The surface of aluminium can be studied to determine the extent of coverage of the aluminium oxide layer using methods such as scanning electron microscopy (SEM).

In a further aspect of the invention, there is provided a method of making a composition, which generates hydrogen when contacted with water, for example a composition as defined in any of the aspects, embodiments and examples herein, the method comprising milling a combination of aluminium particles and optionally where present, one or more metal oxides and/or one or more chloride salts of alkali metals or alkaline earth metals. By milling the compositions, some of the aluminium oxide layer on the aluminium particles can be removed so that a greater surface area of aluminium is exposed for reaction with water.

In one embodiment, the method comprises milling a combination of aluminium particles, an alkaline earth metal oxide, a transition metal oxide and one or more chloride salts of alkali metals or alkaline earth metals. In another embodiment, the method comprises milling a combination of aluminium particles, one or more metal oxides and one or more chloride salts of alkali metals or alkaline earth metals. In yet a further embodiment, the method comprises milling a combination of aluminium particles, an alkaline earth metal oxide, a transition metal oxide and a mixture of NaCl, KCl and CaCl₂).

In the methods of the invention, the aluminium particles, metal oxides and chloride salts, and their relative amounts and ratios, may be as defined above with reference to the compositions of the invention. The term “milling” as used herein refers to a mechanical process in which the surface of the aluminium particles is modified to remove at least some of the aluminium oxide later from the particles. The term “milling” may therefore include processes such as grinding.

The aluminium particles and other components may advantageously be milled using a ball milling device, for example a planetary ball mill device. Ball mills comprise a jar in which the substance(s) to be milled and a milling medium (e.g. balls or pebbles) are placed. The jar is then rotated at high velocities and the centrifugal force imparted on the milling medium during rotation acts to mill the substance.

In the methods of the present invention, the balls are preferably stainless-steel balls and the balls may have a diameter of greater than 4 mm, typically greater than 5 mm, for example 7 mm and the ball mill device may contain 5 or more, typically 6 or more, for example 8 balls.

The ball to powder ratio used in the mill device may be 5:1 or greater, typically 7:1 or greater, for example 10:1.

The aluminium particles and other components may be milled by a ball milling device according to a milling programme comprising a milling cycle in which:
a) the ball milling device is rotated in a first direction for a forward rotation time period;
b) rotation is paused for a first break time period;
c) the device is rotated in a direction opposition to the first direction for a reverse rotation time period;
d) rotation is paused for a second break time period.

The milling cycle is preferably repeated. Thus, for example, the milling programme can comprise at least two, typically at least three, and more usually at least four milling cycles. By way of example, the milling programme can consist of from 5 to 50 milling cycles, e.g. 10 to 40 milling cycles.

The forward or reverse rotation periods of time may be between 30 seconds and 2 minutes, for example 1 minute. The rotation periods of time are typically less than 5 minutes, for example less than 2 minutes. The rotation periods may therefore be between 30 second and 5 minutes, for example between 30 seconds and 2 minutes. In embodiments of the invention, the forward rotation period is the same as the reverse rotation period.

Higher hydrogen yields have been observed with longer break times. The first and second break periods of time may be greater than 5 seconds, typically greater than 10 seconds, for example 30 seconds. The break periods of time are typically less than 2 minutes, for example less than 1 minute. The break periods may therefore be between 5 seconds and 2 minutes, for example between 10 seconds and 1 minute. In embodiments of the invention, the first break period is the same as the second break period.

The milling process may be continued for a total time period of at least 1 hour. Whilst longer milling periods may result in improved hydrogen yield, in practice the milling period used will be a compromise between the hydrogen yield and the cost of running the milling device for long periods of time. Accordingly, the total milling time is typically less than 3 hours, for example less than 2 hours. In one embodiment, the milling programme extends over a period of 1-2 hours.

The speed of rotation may be between 100 rpm and 600 rpm, typically between 200 rpm and 400 rpm, for example between 210 rpm and 310 rpm.

Before milling, the aluminium particles may have a diameter of 200 μm or less, typically 150 μm or less or 100 μm or less, for example 50 μm or less. The aluminium particles, however, typically have a diameter in the micron-range (rather than the nanometre range) and hence the diameter of the aluminium particles before milling is typically greater than 1 μm, for example greater than 5 μm or greater than 10 μm.

Thus, before milling, the aluminium particles may have a diameter of from 1 μm to 200 μm, typically 10 μm to 100 μm.

The diameters stated above were measured using sieving methods. Therefore, the diameters refer to particles that are able or unable to pass through sieves with apertures of a certain size. For example, particles stated as having a diameter of less than 200 μm are able to pass through a circular aperture having a diameter of 200 μm, whereas particles stated as having a diameter of greater than 1 μm are unable to pass through a circular aperture having a diameter of 1 μm.

Also provided by the present invention is a method of generating hydrogen gas comprising contacting a composition as described herein with water.

The compositions of the invention can be used in combination with liquids other than pure water, for example aqueous solutions of salts, sugars, alcohols or other organic compounds. In particular, it has been shown that the compositions of the invention generate water when contacted with aqueous solutions of ethanol, ethylene glycol and urea. The compositions may therefore be used to generate hydrogen in environments where clean water is not readily available.

In a further aspect, the invention provides a container containing a predetermined amount of the compositions of the invention. The container may contain between 1 g and 125 kg of the compositions of the invention. In embodiments of the invention, the container contains an amount selected from:
a) from 10 g to 10 kg;
b) from 10 g to 1 kg;
c) from 50 g to 500 g
d) from 100 g to 200 g
e) from 100 g to 5 kg
f) from 1 kg to 15 kg;
g) from 4 kg to 12 kg; or
h) from 5 kg to 10 kg.
of the compositions of the invention.

For certain uses, such as for use in a hydrogen generating apparatus described in International Patent Applications WO2017/078530 and WO2017/025591 the container may contain between 1 kg and 15 kg, for example between 5 kg and 10 kg of the compositions of the invention. For use in a smaller hydrogen generating apparatus, the container may contain between 10 g and 500 g, for example between 50 g and 250 g.

For each of the embodiments disclosed herein where the composition is stated to comprise one or more components, in further alternative embodiments there are also provided compositions which consist essentially of the one or more listed components. In yet further alternative embodiments, there are also provided compositions which consist of the one or more listed components.

The containers can be loaded into an apparatus for generating hydrogen. The apparatus may then be configured to introduce water into the container to react with the compositions of the invention to generate hydrogen.

The container may be annular in shape. The annular container may have a ring-shaped base portion and (typically concentric) cylindrical inner and outer walls, the space between the inner and outer walls serving to hold the reactants during reaction to form hydrogen. The inner wall typically surrounds a central passage.

The container may have an interior (e.g. the space between the inner and outer walls when present) which is partitioned into a plurality of individual compartments, each of which can contain a dose of a composition of the invention that can react with water to form hydrogen. By providing a plurality of separate compartments each containing an amount of the composition, the generation of hydrogen can be controlled more closely. For example, the compartments can be configured so that water entering the container falls into one or a selected number of (but not all) compartments so that reaction is initiated in the one compartment or selected number of compartments in question, and then flows to other compartments thereby bringing about reaction in those compartments. The compartments can be configured so that liquid from one compartment will only flow to another (e.g. adjacent) compartment when liquid in the one compartment has reached a particular level. Thus, for example, partition walls between the compartments can be configured so that when the liquid in one compartment has reached a particular level, it will overflow into only a single or selected small number of (e.g. one, two or three) adjacent compartments, and preferably only a single adjacent compartment. In this way, the extent of reaction between the compositions of the invention and water can be controlled by controlling the rate of flow of water into container.

When the container has concentric inner and outer walls, the space between the concentric inner and outer walls may be divided into a plurality of compartments by one or more partition walls extending in a radially outward direction from the inner circular wall. One or more further concentric intermediate cylindrical walls may also be provided between the inner and outer walls thereby increasing the number of compartments.

When there are two or more radially extending partition walls, one of the radially extending partition walls may have a height greater than the other radially extending partition walls and the liquid inlet may be positioned so that liquid is initially deposited in a compartment bounded on one side by the higher radially extending partition wall. As liquid is introduced into the compartment, it will eventually overflow in a direction away from the higher radially extending partition wall. Depending on which side of the higher radially extending partition wall the liquid is introduced into a compartment, the liquid flow around the container may be either clockwise or anticlockwise.

Where there are one or more further concentric intermediate cylindrical walls between the inner and outer walls, a more convoluted flow path may be provided by configuring the partition walls between adjacent compartments so that a first compartment (where the liquid is initially received) has a single partition wall of reduced height and all except one of the remaining compartments have two partition walls of reduced height so that liquid can pass from the first compartment sequentially through the other compartments to a final compartment in the flow path, which has only a single partition wall of reduced height.

Alternatively (or additionally), the partition walls separating the compartments can be provided with openings that are arranged to direct the flow of liquid around the container in a predetermined manner. For example, a first compartment (where the liquid is initially received) and the final compartment in the flow path may each have a single opening and the remaining compartments may have two or more (typically only two) openings through which liquid may pass. The term “opening” in the context of the openings in the partition walls can mean either a hole or a notch or cut away region in a wall.

When the container has one or more further concentric intermediate cylindrical walls between the inner and outer walls, each cylindrical intermediate wall may have a height of less than the inner and outer walls (for example, a height of less than half of the height of the outer wall.)

It will be appreciated from the foregoing that by virtue of the radially extending partition wall(s) and, when present, the concentric intermediate wall(s), the interior of the container is configured to provide a discrete number of compartments into which measured weights or volumes of reactant can be added. Each compartment may, for example, contain the same weight of reactant. Alternatively, but less usually, different amounts of reactants can be provided in each compartment.

The water may be introduced into the container through an open top of the container. Alternatively, a side wall of the container may be provided near its upper edge with an opening through which the water can be introduced.

The opening in the side wall of the container may be one which is only created immediately before or during the placing of the container in an apparatus for generating hydrogen. Thus, it may have a closure which is removed to create the opening. The closure may take the form of a frangibly linked break-out portion of the wall.

The container is typically integrally formed (e.g. by a moulding technique such as injection moulding) from a mouldable plastics material, and more preferably a biodegradable plastics material. Alternatively, the container may be formed by machining or 3d-printing a plastics material or formed from a metal material (typically one which is substantially inert to the reactants).

The plastics material is chosen so that it is impervious to water and any other liquids that may be used as a reactant or reaction medium, and is resistant to both the reactants and the reaction products. Examples of suitable plastics materials include acrylonitrile butadiene styrene (ABS), polyamides such as nylon, biodegradable polymers such as polylactic acid/polylactide and mixtures thereof. In one embodiment, the cartridge is formed of a mix of nylon and ABS.

The container may be provided with an alignment guide which engages a complementary guide element in the interior of an apparatus for generating hydrogen so that the container can only be placed in the apparatus in a predetermined orientation. The alignment guide can be, for example, a groove, recess, rib, ridge, protrusion or group of protrusion that engages a complementary groove, recess, rib, ridge, protrusion or group of protrusions in or from an internal wall of the apparatus. More particularly, the alignment guide can be, for example, a groove extending down an outer face of the container, wherein the groove engages a protrusion extending inwardly from the internal wall of the apparatus (for example an internal wall of the lower body section).

### BRIEF DESCRIPTION OF THE DRAWINGS

FIG. 1 is a graph showing the effect of varying the metal oxide present in a milled composition containing aluminium particles, metal oxide and NaCl on the volume of hydrogen generated.

FIG. 2 is a graph showing the effect on hydrogen yield when using a combination of CaO and CuO as metal oxides in a composition containing aluminium particles, metal oxide and NaCl milled using a first milling programme.

FIG. 3 is a graph showing the effect on hydrogen yield when using a combination of CaO and CuO as metal oxides in a composition containing aluminium particles, metal oxide and NaCl milled using a second milling programme.

FIG. 4 is a graph showing the effect on hydrogen yield when varying the proportions of CaO and CuO in a composition containing aluminium particles, CaO, CuO and a combination of KCl, NaCl and CaCl₂).

FIG. 5 is a graph showing the effect on hydrogen yield when varying the nature of the salt in a milled composition containing aluminium particles, CaO, CuO and the salt.

FIG. 6 is a graph showing the effect on hydrogen yield when using a combination of NaCl, KCl and CaCl₂, compared to CaCl₂ alone, in a milled composition containing aluminium particles, CaO, CuO and the salt(s).

FIG. 7 is a graph showing the effect on hydrogen yield when using a combination of NaCl, KCl and CaCl₂), compared to no salts, in a milled composition containing aluminium particles, CaO and CuO.

FIG. 8 is a graph showing the effect of using various milled and non-milled combinations of aluminium particles, metal oxide(s) and salt(s) on hydrogen yield.

FIGS. 9 and 10 are graphs showing the effect of the milling conditions of the compositions of the invention on hydrogen yield.

FIG. 11 is a graph showing the effect of aluminium particle size on hydrogen yield.

FIG. 12 is a graph showing a comparison of hydrogen yield when recycled and ‘pure’ aluminium are used in the compositions of the invention.

FIG. 13 is a graph showing the volume of hydrogen generated by a composition of the invention when contacted with aqueous solutions of ethanol at various concentrations.

FIG. 14 is a graph showing the volume of hydrogen generated by a composition of the invention when contacted with aqueous solutions of ethylene glycol at various concentrations.

FIG. 15 is a graph showing the volume of hydrogen generated by a composition of the invention when contacted with aqueous solutions of urea at various concentrations.

### EXPERIMENTAL SECTION

Methods

Particle Synthesis

In the Examples below, the following method was used to prepare the aluminium-containing compositions of the invention.

Prior to milling, all powders were dried in a vacuum furnace (Townson and Mercer Ltd) for 24 hrs to remove any excess moisture. After drying, the powders were kept in a desiccator inside an oxygen-free glove box (Saffron Scientific Alpha) which was purged with 99.99% pure argon gas to ensure a moisture and oxygen-free environment. Inside the glove box, an oxygen sensor (SYBRON Taylor) was placed to measure the level of oxygen within an accuracy of ±0.01%.

Below is a list of the components used in the milling process for the aluminium-containing compositions of the invention.
Aluminium recycled (99.1 wt %, sieved further with 40 μm, 75 μm and 105 μm mesh, obtained from iHOD USA).
Aluminium pure (99.5 wt %, Alfa Aesar, 200 mesh, Fisher Chemical).
Calcium oxide (99.0 wt % CaO, 65 μm, Fisher Chemical).
Copper oxide (99.0 wt % CuO, nanoparticles, ACROS Organics).
Barium oxide (90.0 wt % BaO, nanoparticles, ACROS Organics).
Potassium chloride (99.5 wt % KCl, 65 μm, Fisher Chemical).
Calcium chloride (80 wt % CaCl₂, 280 μm, VWR Chemical).
Sodium chloride (98.0 wt % NaCl, 150 μm, Fisher Chemical).

Unless stated otherwise, recycled aluminium powder as received from iHOD USA was used. This aluminium powder contained a blend of different particle sizes and therefore the recycled aluminium was sieved to provide 3 different particle size ranges to establish the effect of different particle sizes on hydrogen yield. For this purpose, sieves BS410/1986 (Endecott Test Sieve shaker E.F.L Mark II with Endecott's Ltd) with sizes ranging from 3 μm to 300 μm were employed. The sieves were placed in descending size order on top of each other and on the top-most sieve (300 μm mesh size) aluminium powder was dispensed. The sieving process was carried out for 48 hrs.

After separation had taken place, sieves corresponding to particle diameters of 40 μm, 70 μm and 100 μm were selected. The particles in the 40 μm sieve had a diameter between 40 μm and 50 μm, the particles in the 70 μm sieve had a diameter between 70 μm and 80 μm and the particles in the 100 μm sieve had a diameter of between 100 μm and 110 μm.

Powder preparation for milling was performed under anaerobic condition inside a glove box before being transferred to a planetary ball mill device for milling. All percentage weights of the components of the composition are given as a weight percentage with reference to the total weight of the composition.

For the ball milling, a ball-to-powder ratio of 10:1 by weight was used. Eight milling balls (spherical stainless-steel balls 7 mm diameter) and 3 g of aluminium powder along with chosen additives were placed into a 50 ml stainless steel milling jar while inside the glove box. The sealed assembly from the glove box was then transferred to a planetary ball mill device (Retsch PM-100). The total weight of the milling jar was adjusted with a counter balance on the milling machine station to avoid imbalance and rattling during high-speed milling.

Different milling programmes were set up in which the direction of rotation of the mill and the milling speeds were altered. Details of the milling programmes used are provided in Table 1 below:

TABLE 1
Milling Programmes

| Milling | Total | | | | | |
|---|---|---|---|---|---|---|
| Pro- | milling | Milling | Speed of | Break between | | Directions of |
| gramme | time | period | milling | milling periods | | milling |
| 1a | 1 hr and | 1 min | 258 rpm | 30 | sec | Anticlockwise/ |
| | 38 min | | | | | Clockwise |
| 1b | 1 hr and | 1 min | 518 rpm | 30 | sec | Anticlockwise/ |
| | 38 min | | | | | Clockwise |
| 1c | 2 hr and | 1 min | 518 rpm | 30 | sec | Anticlockwise/ |
| | 38 min | | | | | Clockwise |
| 1d | 2 hr and | 1 min | 518 rpm | 30 | sec | Anticlockwise/ |
| | 24 min | | | | | Clockwise |
| 2a | 1 hr and | 1 min | 258 rpm | 5 | sec | Anticlockwise/ |
| | 38 min | | | | | Clockwise |
| 2b | 1 hr and | 1 min | 518 rpm | 5 | sec | Anticlockwise/ |
| | 38 min | | | | | Clockwise |

Programmes 1a to 1d differed in milling speed and total milling time only and consisted of 1 min milling, a 30 sec break followed by a further 1 minute of milling with rotation in the opposite direction and another 30 sec break. This was repeated until a total milling time 1 hr and 38 min (for programmes 1a and 1b) and 2 hr and 24 min (for programmes 1c and 1d) was reached.

Programmes 2a and 2b were used to test the importance (if any) of the intermediate break time where the break time was set to 5 sec instead of 30 sec as it was for Milling Programme 1a and 1b.

Measuring Yield of Hydrogen

In the Examples below, the following method was used to measure the amount of hydrogen liberated upon reaction of the aluminium-containing compositions of the invention with water (or other selected liquids).

A Pyrex® glass tube (60 ml, inner diameter: 21 mm) was used as the reaction vessel. A rubber stopper with 2 holes acted as a sealant for the connections. One of the holes in the stopper provided the exit channel for the hydrogen that was liberated in the reaction whereas the other hole was used to insert a thermocouple (k-type) connected to a digital data logger (Picotech, Model: 2204) in order to monitor the temperature.

Before the start of the reaction, the vessel was thoroughly purged with pressurised argon gas in order to keep the concentration of oxygen in the vessel as low as possible. 0.3 g of an aluminium-containing composition (prepared using the method described above) was added to the reactor followed by 9 ml water (or other liquid as specified in the Examples below) at 25° C. which was added using a syringe. The reactor vessel was wrapped with an insulating polystyrene sheet. The mixing of water and the composition was accomplished by agitation using a small capsule-shaped stirrer bar (5 mm, 1 g) and a magnetic stirring plate (IKA-RH-Basic 2) used to set the agitation speed at 300 rpm. The size and the weight of the stirrer allowed free movement of particles inside the reactor.

The hydrogen gas generated was passed through a series of stainless steel pipes (internal diameter: 7 mm) with three elbow compression joints and one push-fit joint to avoid any gas leakage.

Two methods were employed to measure the rate of hydrogen generation and the total amount of hydrogen generated; one being inverted column method and the other involving the use of a gas mass flow meter. The gas mass flow meter had ±0.01 ml accuracy in the flow range of 0-10 ml/min. The gas flow meter was pre-calibrated for hydrogen gas.

To ensure that dry gas entered the gas flow meter, a reinforced plastic tube joint (5 cm×3 cm) containing a desiccant (silica gel) was attached to a gas mass flow meter (Aalborg GFM-17). The hydrogen produced was recorded via a data logger connected to a PC using the relevant Pico Logger software with sample intervals of 1 sec. The connections to the data logger enabled both the hydrogen flow rate and temperature to be read and recorded simultaneously. In order to analyse the quality of the gas produced, a gas-tight syringe was used to collect the gas and introduce the gas into a gas analyser (gas chromatogram, GC).

The % hydrogen yield values as reported below were calculated based on the theoretical maximum amounts of hydrogen that could be liberated from a 0.3 g composition containing 65% by weight of aluminium (i.e. 0.195 g of aluminium)—unless stated otherwise. This amount corresponds to 264.8 mL of hydrogen gas at 20° C. and 1 atm pressure (101,325 Pa).

### EXAMPLES

### Example 1

Comparison of Hydrogen Yields with Different Metal Oxides

Compositions were prepared comprising aluminum particles (diameter: 70 μm to 80 μm, obtained as described above), sodium chloride (NaCl) and various metal oxides in the proportions shown in Table 2. The selected metal oxides for this study were barium oxide (BaO), calcium oxide (CaO) and copper oxide (CuO). The powders were milled using Milling Programme 1b, as described in the Methods Section above, using a mill speed of 518 rpm and a total milling time of 1.1 hr.

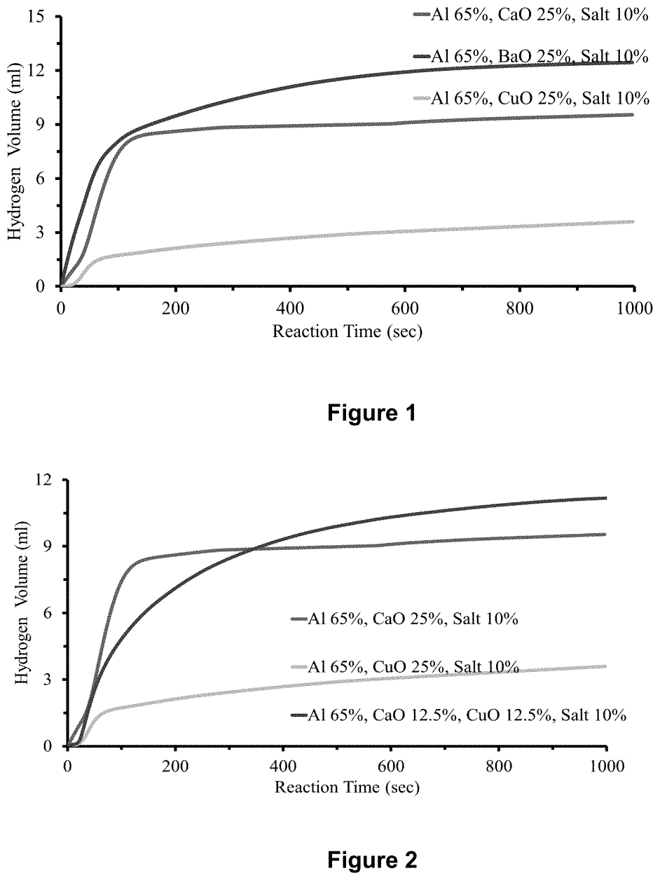

The yield of hydrogen after 1000 seconds is shown in FIG. 1 and Table 2 below. The % hydrogen yield shown in Table 2 is relative to the maximum theoretical yield of hydrogen for the aluminum contained in the composition.

TABLE 2
Powder composition with different metal oxide additives.

| | % Hydrogen Yield |
|---|---|
| Powder composition (wt %) | after 1000 sec |
| Al 65%, BaO 25%, NaCl 10% | 4.5% |
| Al 65%, CaO 25%, NaCl 10% | 3.8% |
| Al 65%, CuO 25%, NaCl 10% | 1.4% |

In FIG. 1, it can be seen when using BaO, hydrogen gas was produced instantly and a total of 12 ml of hydrogen was generated in 1000 sec (corresponding to 4.5% hydrogen yield). For CaO and CuO, the yields of hydrogen were much lower and the generation of hydrogen was minimal after 600 and 400 sec respectively.

### Example 2

Use of a Combination of Metal Oxides

Compositions were prepared comprising aluminum particles (diameter: 70 μm to 80 μm, obtained as described above), sodium chloride (NaCl) and various metal oxides in the proportions shown in Table 3. The selected metal oxides for this the study were calcium oxide (CaO), copper oxide (CuO) and equal proportions of CaO and CuO (but with the total weight of metal oxides being kept to 25% of the total composition). For this study, all the powders were milled using Milling Programme 1b or 1d, as described in the Methods section above.

TABLE 3
Powder composition with different metal oxide additives.

| | Milling | % Hydrogen Yield |
|---|---|---|
| Powder composition (wt %) | Programme | after 1000 sec |
| Al 65%, CaO 25%, NaCl 10% | 1b | 3.7% |
| Al 65%, CuO 25%, NaCl 10% | 1b | 1.5% |
| Al 65%, CaO 12.5%, | 1b | 4.2% |
| CuO 12.5%, NaCl 10% | | |
| Al 65%, CaO 25%, NaCl 10% | 1d | 2.2% |
| Al 65%, CuO 25%, NaCl 10% | 1d | 1.8% |
| Al 65%, CaO 12.5%, | 1d | 5.3% |
| CuO 12.5%, NaCl 10% | | |

Table 3 and FIG. 2 show the hydrogen yields of the three compositions prepared by Milling Programmes 1b and 1d. For the composition containing the combined metal oxide milled using Milling Programme 1b, a total of 11 ml hydrogen was produced after 1000 sec which is comparable to the previous use of the BaO additive, (see Example 1).

It can be seen that when a combination of the two metal oxides (CaO and CuO) were used, there was more of an immediate, albeit slower rise in the generation of hydrogen whereas there was a delay in production of hydrogen when CaO or CuO were used separately in the mixture. CuO was also observed to produce a lower volume of hydrogen over 1000 seconds.

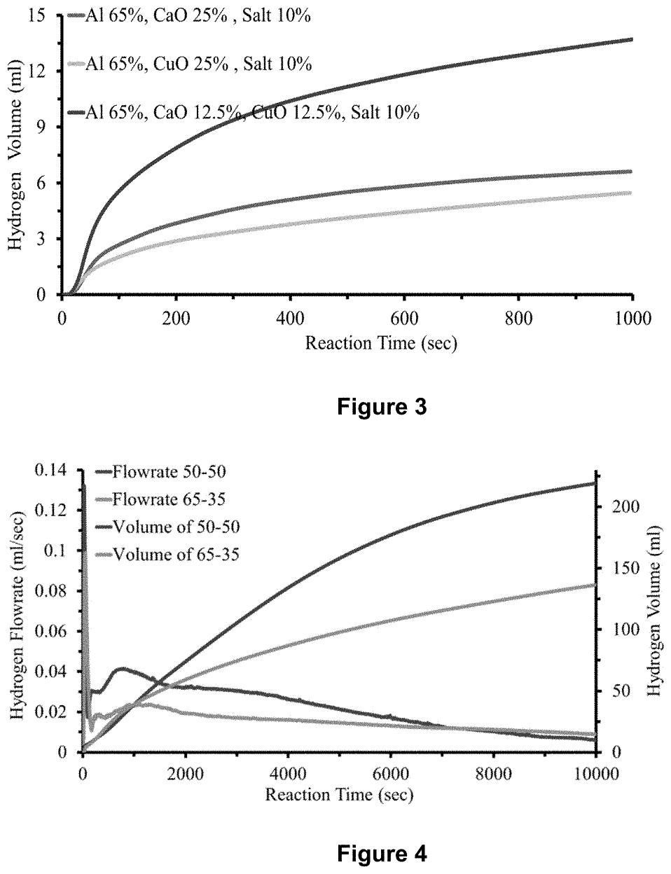

Table 3 and FIG. 3 show the hydrogen yields of the three compositions prepared by Milling Programme 1d. Milling Programme 1d differed from Milling Programme 1b in that the total milling time was increased from 1.1 hr to 2.4 hr. In FIG. 3, it can be seen that the composition containing the combined metal oxides produced 13 ml hydrogen after 1000 sec while the compositions containing only CaO or CuO produced only 6 ml and 5 ml, respectively. In addition, it was noted that the high reaction rate seen previously for the CaO sample when it was milled for 1.1 hrs had also been affected, with it resulting in an inferior hydrogen yield after 1000 sec.

### Example 3

Varying the Metal Oxide Ratios

To further explore the increased hydrogen yield when using combined metal oxide additives, different ratios of the two metal oxides were tested. Compositions were prepared comprising aluminum particles (diameter: 70 μm to 80 μm, obtained as described above), a mixture of sodium chloride (NaCl), potassium chloride (KCl) and calcium chloride (CaCl₂)) and various metal oxides in the proportions shown in Table 4. For this study, all the powders were milled using Milling Programme 2a.

TABLE 4
Powder compositions with different ratios of CuO and CaO

| | % Hydrogen Yield |
|---|---|
| Powder composition (wt %) | after 10,000 sec |
| Al 65%, CaO 12.5%, CuO 12.5%, NaCl 4%, | 85 |
| KCl 3%, CaCl₂ 3% | |
| Al 65%, CaO 8.75%, CuO 16.25%, NaCl 4%, | 53 |
| KCl 3%, CaCl₂ 3% | |

The volume of hydrogen produced by samples with a CuO:CaO ratio corresponding to 65 wt %: 35 wt % (sample 65-35) was compared to 50 wt % CuO and 50 wt % CaO (sample 50-50). The hydrogen flow rate and the volume of hydrogen generated by each composition can be seen in FIG. 4. Sample 50-50 displayed a higher flow rate than sample 65-35. This was approximately twice as high, e.g. at 1000 sec (rate of 0.04 ml/s for sample 50-50 versus 0.02 ml/s for sample 65-35.)

The difference can also be seen in the generated hydrogen volume on the right-hand y-axis of FIG. 4, where the sample 50-50 produced 220 ml (85% H₂ yield) after 10,000 sec compared with 140 ml (53% H₂ yield) for sample 65-35 after the same period of time.

### Example 4

Use of a Combination of Chloride Salts

Each of NaCl, KCl and CaCl₂ were milled together with aluminium powder and CaO and CuO in equal proportions as listed in Table 5. This mixture of CaO and CuO is referred to below as MO. The powers were milled using Milling Programme 1a, as described in the Methods Section above.

TABLE 5
Composition of additives in the sample.

| | % Hydrogen Yield |
|---|---|
| Powder composition (wt %) | after 1000 sec |
| Al 65%, CaO 12.5%, CuO 12.5%, | 5.7% |
| NaCl 10% | |
| Al 65%, CaO 12.5%, CuO 12.5%, | 5.3% |
| KCl 10% | |
| Al 65%, CaO 12.5%, CuO 12.5%, | 8.3% |
| CaCl₂ 10% | |
| Al 65%, CaO 12.5%, CuO 12.5%, | 12.8% |
| NaCl 4%, KCl 3%, CaCl₂ 3% | |

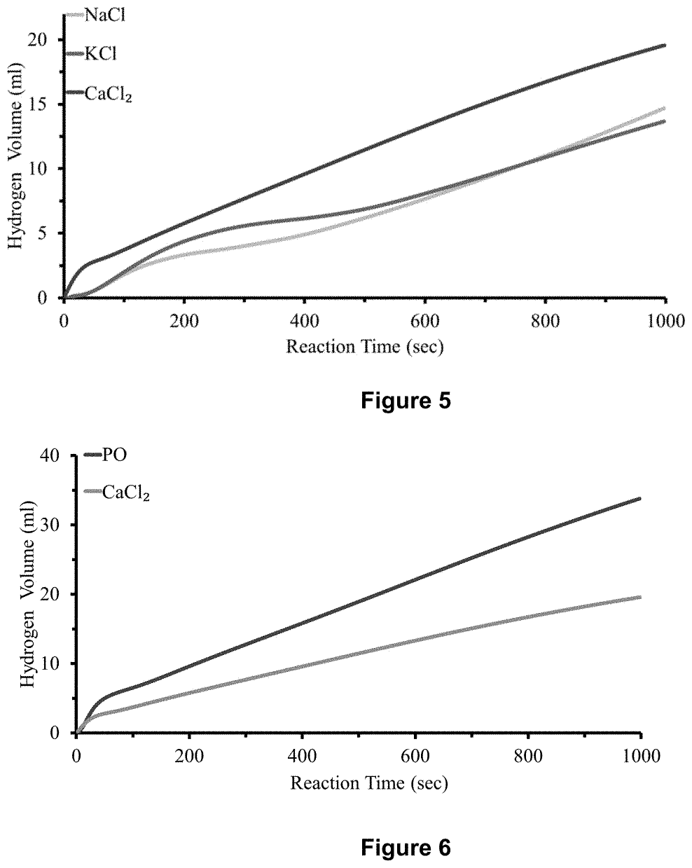

As FIG. 5 and Table 5 show, it is clear that by using 10 wt % CaCl₂, hydrogen gas is generated both more immediately and in a greater amount compared to NaCl and KCl within the first 1000 sec of reaction. At 1000 sec the CaCl₂) sample had generated 22 ml of hydrogen compared with 15 ml for NaCl and 14 ml for the KCl sample.

The three salts were mixed together to determine the effect of using a combination of chloride salts. The mixture (hereinafter referred to as “PO”) contained three salts; CaCl₂), NaCl and KCl in a ratio of 3:4:3 respectively. Furthermore, to investigate if there was synergistic effect, salt additive PO was tested against CaCl₂). Milling Programme 1a was used to mill both compositions.

It can be seen from Table 5 and FIG. 6 that the hydrogen yield is increased when using a mixture of the three chloride salts compared with CaCl₂) only. After only 600 sec, the composition containing PO had generated 22 ml of hydrogen gas compared to 13 ml for the composition containing CaCl₂) only. This can be compared to 9 ml from NaCl or KCl from demonstrating its superiority over them.

To further explore the effect of salt additives, two powders were prepared. One contained all the additives, i.e. (Al+MO+PO) and other which had no salt additive, i.e. powder (Al+MO). These are called “No PO” and “Wth PO” in the results, respectively.

Here it was necessary to adjust the weight % accordingly. The absence of salt in the sample No PO was adjusted by increasing the portion of metal oxides to keep the Al:MO ratio 65:35.

Powders were milled using Milling Programme 1a at 258 rpm and reacted with deionised water at 25° C. for 10000 sec.

TABLE 6
Effect of removing salts from the composition.

| | % Hydrogen Yield |
|---|---|
| Powder composition (wt %) | after 4000 sec |
| Al 65%, CaO 12.5%, CuO 12.5%, | 50% |
| NaCl 4%, KCl 3%, CaCl₂ 3% | |
| Al 65 wt %, CaO 17.5 wt %, and CuO | 19% |
| 17.5 wt % | |

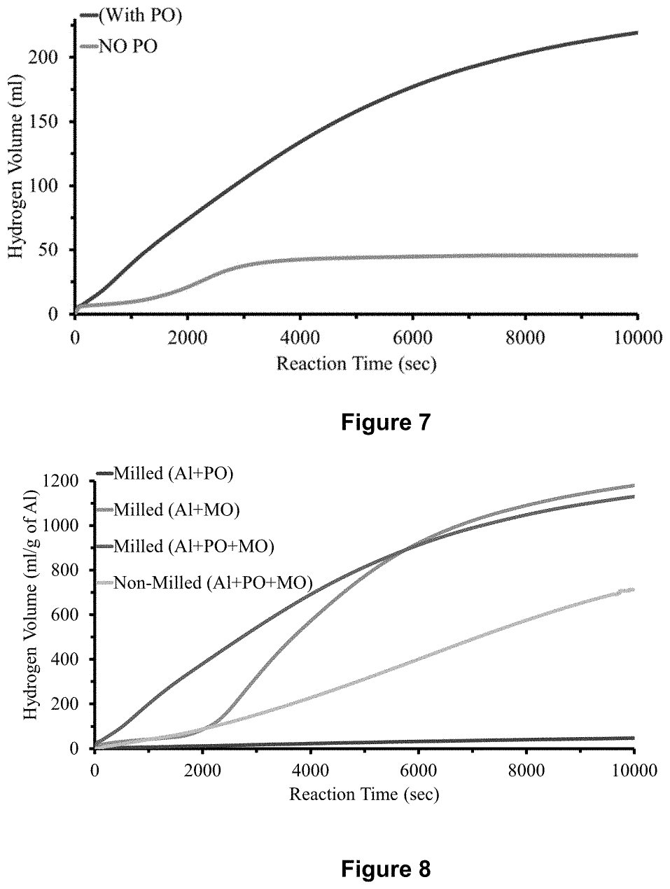

From Table 6 and FIG. 7, it can be seen that milled “No PO” powders only produced 48 ml of H₂ in 4000 sec and after that stopped producing any further hydrogen. On the other hand, the PO-containing powder displayed an increased hydrogen yield. In the first 4000 sec, the “With PO” sample generated 130 ml (50% yield) while only 48 ml of hydrogen (19% yield) was generated for the “No PO” sample.

Another important observation is that for “No PO” sample the reaction rate is slow for the first 1700 sec and then increases rapidly until 3000 sec reaction time where the reaction then appears to come to a halt.

### Example 5

Combined Effect of Metal Oxides and Chloride Salts

To investigate the importance of milling and the additives to the volume of hydrogen produced, it was decided to prepare three samples via milling and a further sample without milling.

TABLE 7
Comparison of Compositions

| | | | Hydrogen |
|---|---|---|---|
| | | Milling | Yield after |
| Name | Composition | Programme | 10,000 sec |
| Al + MO | Al 65%, CaO 17.5%, | Milling | 94% |
| | CuO 17.5% | Programme 1a | |
| Al + PO | Al 65%, NaCl 14%, | Milling | 0.02% |
| | KCl 10.5%, CaCl₂ 10.5% | Programme 1a | |
| Al + MO + PO | Al 65%, CaO 12.5%, | Milling | 85% |
| | CuO 12.5%, NaCl 4%, | Programme 1a | |
| | KCl 3%, CaCl₂ 3% | | |
| Al + MO + PO | Al 65%, CaO 12.5%, | No milling | 54% |
| | CuO 12.5%, NaCl 4%, | | |
| | KCl 3%, CaCl₂ 3% | | |

From FIG. 8, it can be seen that whilst the total yield of hydrogen after 10,000 seconds was slightly greater for the composition containing aluminium and MO (Al+MO) only compared to the composition with both additives (Al+PO+MO), for the composition containing both additives, the rate production of hydrogen was fairly constant for the first 6,000 seconds, after which point the rate of production steadily decreased. By contrast, for the composition containing aluminium and MO only, for the first 2,000 seconds the amount of hydrogen generated was low. This was followed by a sharp rise where large quantities of hydrogen were generated is a short period of time between 2,000 and 5,000 seconds. Therefore, whilst the overall hydrogen yield was slightly higher for the Al+MO composition than for the Al+PO+MO composition, the Al+PO+MO composition has the advantage that the rate of hydrogen generation is much more constant. It is therefore envisaged that this composition would be more useful in an apparatus where a steady rate of hydrogen generation is required over a period of 2 to 3 hours.

Without milling, the same composition produced only 700 ml hydrogen per gram of aluminium after 10000 sec, corresponding to an approximate hydrogen yield of 54%.

For the same reaction time, sample (Al+MO+PO) had already produced a volume of hydrogen of 400 ml/g Al. Furthermore, when 0.3 g of (Al+PO+MO) was allowed to react with 9 ml water for 12000 sec, it produced a total of 235 ml which correspond to a hydrogen yield of 90% per amount of metal reacted.

The hydrogen yields when either the metal oxides or the PO salt mix were omitted were significantly reduced.

### Example 6

Effect of Milling Conditions on Hydrogen Yield

The effect of varying the milling conditions on the hydrogen yield of the milled compositions was studied. The compositions contained aluminum powder (40 μm to 50 μm, obtained as described above) 65%, calcium oxide 12.5%, copper (II) oxide 12.5%, NaCl 4%, KCl 3% and CaCl₂) 3%.

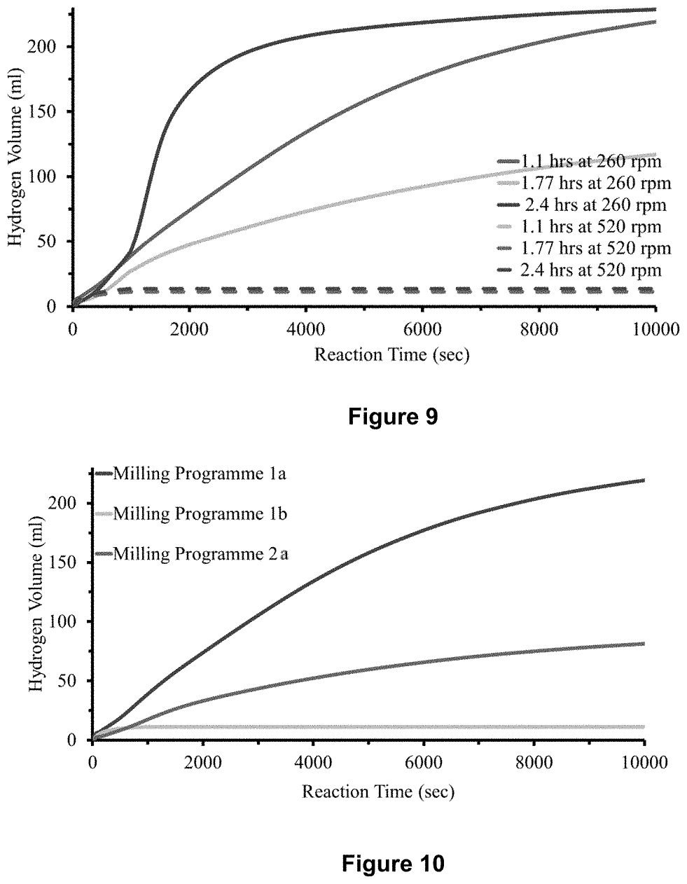

As can be seen in FIG. 9, when the powder prepared at 258 rpm was reacted with deionised water, hydrogen generation occurred progressively across the whole 1000 sec and was still ongoing at 10000 sec regardless of milling durations. The volume of hydrogen for compositions milled at 258 rpm for total milling times of 1.1, 1.77 and 2.4 hrs were 220 ml, 170 ml and 230 ml respectively. This corresponded to respective hydrogen yields of 85%, 65% and 88%.

Results for compositions milled at 518 rpm showed no progressive hydrogen generation and after 1000 sec only ˜13 ml of hydrogen was generated (corresponding to a yield of 4.9%). After 10000 sec no further hydrogen appeared to be produced.

In addition, three milling programmes—1a, 1b and 2a (described in the Methods Section above)—were compared for their effects on hydrogen production. Similar to previous study all the compositions of the additives (Al 65 wt %, MO 25 wt %, Salt 10 wt %) including particle aluminium particles size, i.e. 40 μm were kept constant.

As can be seen in FIG. 10, there is a striking difference in hydrogen production between three different Milling Programmes. Milling Programme 2a produces far less hydrogen (total of 80 ml, 30% yield) after 10000 sec compared with Milling Programme 1a (220 ml, 85% yield). However, Milling Programme 1 b produced the lowest volume with only 13 ml of hydrogen (5% yield).

### Example 7

Effect of Aluminium Particles

The effects of using recycled aluminium rather than non-recycled aluminium and the aluminium particle size used in the compositions of the invention were also investigated.

Recycled aluminium (provided by iHOD USA LLC) with particle size 3-200 μm was sieved to obtain representative batches of particles having diameters of 40 μm, 75 μm and 105 μm sizes prior milling. The different sized batches were then mixed with the additives (CaO 12.5%, CuO 12.5%, PO 10%) and milled using Milling Programme 1a.

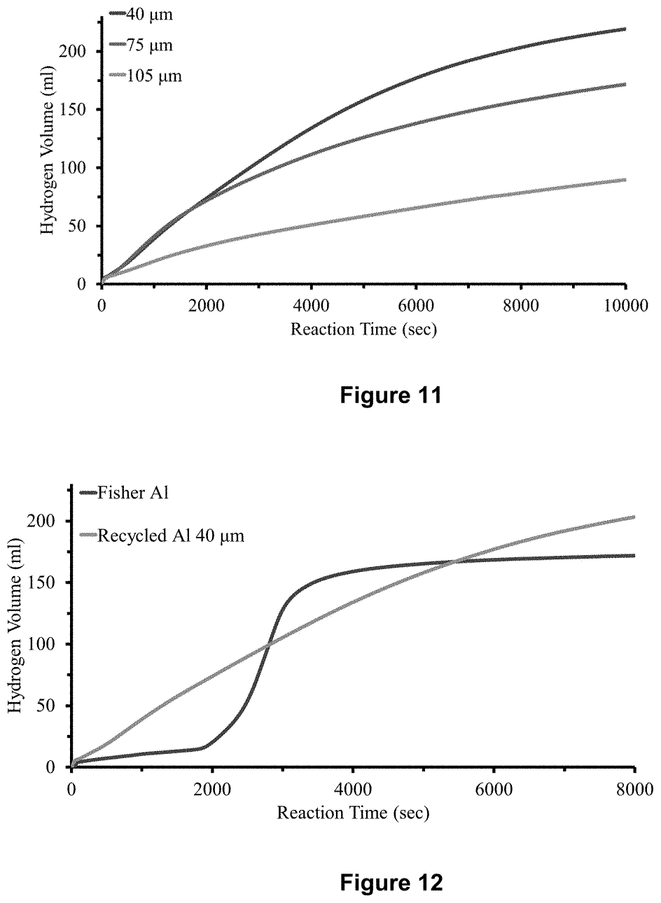

In FIG. 11, the plotted results show the effect that the particles size has on the production of hydrogen. It can be seen that for the compositions made from recycled aluminium, particle size does have an effect on the yield of hydrogen. The smallest starting Al particle size, 40 μm, showed the highest hydrogen generation followed by 75 μm, whereas 105 μm was considerably slower and produced the least amount of hydrogen of them all.

At 10000 sec reaction time, the 40 μm batch had produced 220 ml, the 75 μm batches produced slightly less of 172 ml and the largest sized recycle aluminium particle batch of 105 μm only produced 90 ml hydrogen corresponding to a hydrogen yields of 85%, 66% and 35%, respectively.

To continue the study, a 40 μm recycled Al batch was compared to 10 μm-diameter aluminium particles (obtained from Fisher Chemicals, 99.9% purity) named “Fisher Al”. For comparison, powder compositions were kept same as for above experiments, i.e. (Al 65 wt %, CaO 12.5 wt %, CuO 12.5 wt % and PO 10 wt %) and both powders were prepared using Milling Programme 1a (258 rpm). The volume of hydrogen produced from each sample can be seen in FIG. 12.

A distinctive reaction lag time of up to 2000 sec was observed in the case of Fisher Al particles, but a much shorter lag was witnessed for the Recycled Al 40 μm sample. The flow rate of hydrogen generated from the Fisher Al particles continued to rise until the 2800 sec mark, after which a levelling off was observed. The amount of hydrogen generated by the Fisher Al corresponded to 85% hydrogen yield compared to 220 ml by “Recycled Al 40 μm” corresponding to 92% hydrogen yield, both after 10000 sec reaction time.

### Example 8

Reaction of Compositions with Other Liquids

The reaction of the compositions of the invention with aqueous solutions of ethanol, ethylene glycol and urea were investigated to determine the suitability of the compositions to generate hydrogen in environments where clean water is not readily available. The compositions were prepared according to the methods described above using aluminium particles (65 wt %) with a diameter of 70-80 μm. The compositions also contained 12.5 wt % CaO, 12.5 wt % CaO and 10 wt % PO salt mix and were prepared using Milling Programme 1a (258 rpm).

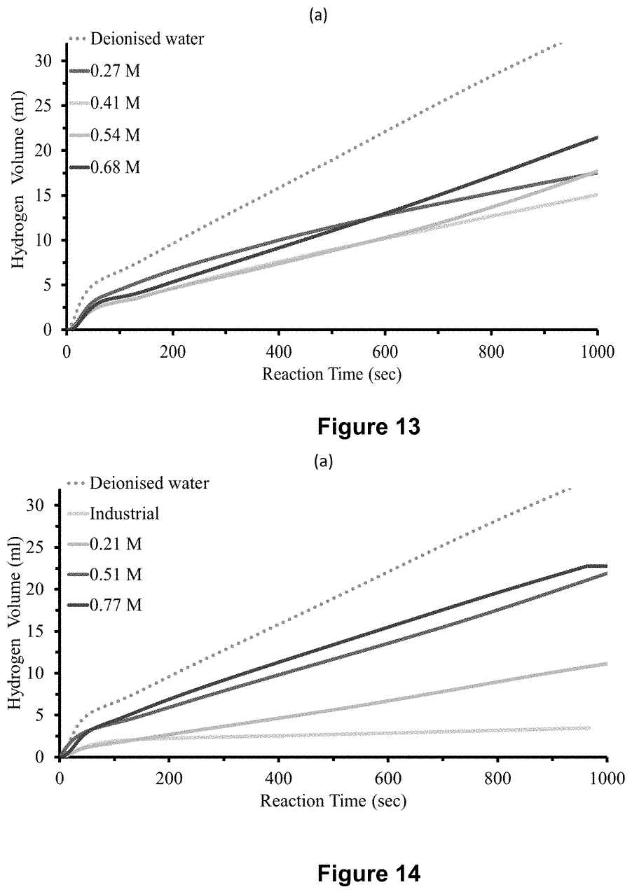

In FIG. 13, the results of the hydrogen formation reactions with different concentration of ethanol solutions are displayed. It can be seen that regardless of the concentration, ethanol solutions were able to produce hydrogen gas. With the highest concentration of 0.68 M, 25 ml of hydrogen gas was liberated in a 1000 sec reaction, corresponding to a hydrogen yield of 9.4%.

In FIG. 14, the results of the hydrogen formation reactions with different concentrations of ethylene glycol and an industrial commercially available antifreeze (Q8 antifreeze, ethylene glycol content of >90% according to the product specification) are displayed. It can be seen that increasing the concentration of ethylene glycol up to 0.77 M appears to improve the hydrogen formation. In contrast, the commercial antifreeze produced the least amount of hydrogen.

Urea solutions were prepared according to D. F. Putnam, Composition and concentrative properties of human urine. NASA Report (1971). Urea (CH₄N₂O, Mr=60.05 g/mol) powder was mixed with deionised water to make solutions of concentrations 0.101M (0.66 g), 0.15M (0.9 g), and 0.05M (0.35 g). As the concentration was increased, the salts weight percentage, i.e. NaCl and KCl wt % were also increased and were dissolved into the urea solution to represent the actual levels of human urine. Once the mixing had finished the beaker in which the solutions were kept were tightly sealed and stored in an inert atmosphere at 17° C. to avoid any oxidation and ammonia formation.

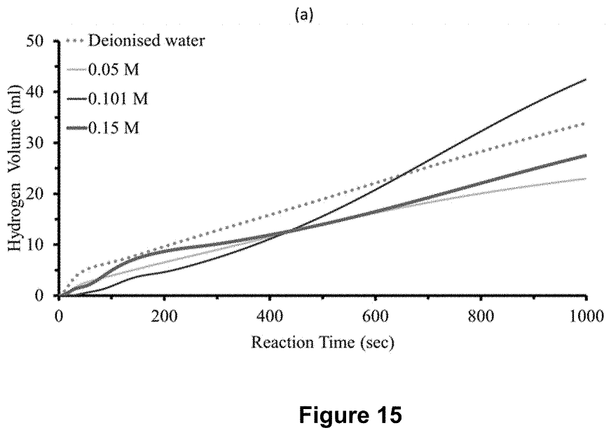

As shown in FIG. 15, the highest concentration of urea, i.e. 0.15 M liberated 43 ml of hydrogen in a 1000 sec reaction. This corresponds to a hydrogen yield of 16%. The use 0.15M solution of urea generated a larger volume of hydrogen compared to when deionised water was used by approximately 10 ml (3.8%).

The embodiments described above and illustrated in the accompanying figures and tables are merely illustrative of the invention and are not intended to have any limiting effect. It will readily be apparent that numerous modifications and alterations may be made to the specific embodiments shown without departing from the principles underlying the invention. All such modifications and alterations are intended to be embraced by this application.

1. A particulate composition, which generates hydrogen when contacted with water, the composition comprising particles of:
aluminium;
an alkaline earth metal oxide;
a transition metal oxide; and
one or more chloride salts of alkali metals or alkaline earth metals.

2. The composition according to claim 1 comprises a plurality of chloride salts of alkali metals or alkaline earth metals.

3. The composition according to claim 2 wherein the chloride salts comprise a mixture of KCl, NaCl and CaCl₂).

4. A particulate composition, which generates hydrogen when contacted with water, the composition comprising particles of:
aluminium;
one or more metal oxides; and
a mixture of NaCl, KCl and CaCl₂) chloride salts.

5. The composition according to claim 4 comprising an alkaline earth metal oxide and a transition metal oxide.

6. A particulate composition, which generates hydrogen when contacted with water, the composition comprising particles of:
aluminium;
an alkaline earth metal oxide;
a transition metal oxide; and
a mixture of NaCl, KCl and CaCl₂).

7. The composition according to claim 1 wherein the transition metal oxide is a first-row transition metal oxide.

8. The composition according to claim 7 wherein the first-row transition metal oxide is a first-row transition metal (II) oxide.

9. The composition according to claim 8 wherein the first-row transition metal (II) oxide is copper (II) oxide.

10. The composition according to claim 1 wherein the alkaline earth metal oxide is CaO, BaO, MgO or a mixture thereof.

11. The composition according to claim 10 wherein the alkaline earth metal is CaO.

12. The composition according to claim 1 wherein the alkaline earth metal oxide and the first-row transition metal oxide are present in the composition in a ratio of 0.65:0.35 to 0.35:0.65.

13. The composition according to claim 12 wherein the alkaline earth metal oxide and the first-row transition metal oxide are present in the composition in a ratio of 1:1.

14. The composition according to claim 3 comprising a mixture of NaCl, KCl and CaCl₂) in a ratio by weight of 3.5-4.5:2.5-3.5:2.5-3.5 respectively.

15. A particulate composition, which generates hydrogen when contacted with water, the composition comprising:
60 to 70% by weight of aluminium particles;
10 to 15% by weight of a group II metal oxide;
10 to 15% by weight of copper (II) oxide;
3.5 to 4.5% by weight of NaCl;
2.5 to 3.5% by weight of KCl; and
2.5 to 3.5% by weight of CaCl₂).

16. A particulate composition according to claim 1 wherein a proportion of aluminium oxide has been removed from the surface of the aluminium particles.

17. A method of making a particulate composition according to claim 1, the method comprising milling a combination of aluminium particles and, where present, one or more metal oxides and/or one or more chloride salts of alkali metals or alkaline earth metals.

18. A method according to claim 17 wherein the milling is conducted using a planetary ball mill.

19. A method according to claim 18 wherein the milling is conducted using 5 or more balls having a diameter of greater than 5 mm.

20. A method according to claim 18 or claim 19 wherein the milling is conducted according to a milling programme comprising a milling cycle in which:
a) the ball milling device is rotated in a first direction for a forward rotation time period;
b) rotation is paused for a first break time period;
c) the device is rotated in a direction opposition to the first direction for a reverse rotation time period;
d) rotation is paused for a second break time period.

21. A method according to claim 20 wherein the milling cycle is repeated and the milling programme consists of from 5 to 50 milling cycles.

22. A method according to claim 20 wherein the rotation time lasts between 30 seconds and 2 minutes.

23. A method according to claim 20 wherein the break time lasts for greater than 10 seconds.

24. A particulate composition obtained by the method of claim 17.

25. A method of generating hydrogen comprising contacting a particulate composition of claim 1 with water.
